(19) United States
(12) Patent Application Publication
(10) Pub. No.: US 2025/0276437 A1
(43) Pub. Date: Sep. 4, 2025

(54) STORAGE COMPATIBLE TRANSFORMABLE CREEPER

(71) Applicant: Techtronic Cordless GP, Anderson, SC (US)

(72) Inventors: Carl N. Chandler, Greenville, SC (US); Joshua Paul Collins, Easley, SC (US); Grant A. Wood, Greenville, SC (US); Nicholas S. Norton, Anderson, SC (US); Michael Keith Saporsky, Greenville, SC (US)

(21) Appl. No.: 19/065,348

(22) Filed: Feb. 27, 2025

Related U.S. Application Data
(60) Provisional application No. 63/560,950, filed on Mar. 4, 2024.

(51) Int. Cl. B25H 5/00; B25H 3/06

(52) U.S. Cl. CPC B25H 5/00; B25H 3/06

(57) ABSTRACT

A transformable creeper and a storage system are provided. The creeper is configured to transform between a horizontal position for supporting a worker in a supine position and a seat position for supporting the worker working in an upright seating position. The creeper includes a base section and an upper section, each having a longitudinally extending frame having side supports and transverse supports extending between the side supports; and wheels configured to enable mobility of the creeper along a floor surface; at least one pair of pivotally mounted arms coupled to both the upper section and the base section, the pair of pivotally mounted arms being pivotable between the horizontal position and the seat position; and at least one storage support interface.

### CROSS-REFERENCE TO RELATED APPLICATIONS

The present application claims priority to U.S. Provisional Patent Application No. 63/560,950, filed on Mar. 4, 2024, the disclosure of which is incorporated by reference herein in its entirety.

### FIELD

The present disclosure relates generally to a creeper, such as an automotive or mechanic's creeper, and more particularly to a creeper that is transformable between a horizontal configuration and an upright seat configuration and is compatible with storage systems.

### BACKGROUND

During the performance of maintenance on automobiles and the like, it is often required that the mechanic be able to work under the chassis of the automobile. In the past, it has been known to use flat surfaces on wheels, known as creepers, enabling the mechanic to lie in a supine position and survey and work underneath the automobile. Additionally, it is known to use work bays where cars may be placed on hydraulic lifts and elevated to a position above an upright mechanic. Furthermore, mechanics sometimes use seats when working about the exterior of an automobile.

The problem has arisen in that the work area around the automobile quickly becomes congested considering that several tools are used on an automobile, such as computer aided diagnostics and general hand held tools, along with replacement parts lying around the work area, in addition to space taken up by the creeper. Additionally, lights may be necessary to illuminate the space under the chassis of the automobile. Moreover, one or more power sources may be required to power the diagnostic and/or power tools required by a user. Accordingly, the work area may be further congested and making it more difficult for an orderly work place to be maintained by the mechanic.

Accordingly, improved creepers are desired in the art. In particular, creepers which provide improved storage and accessory functionality would be advantageous.

### BRIEF DESCRIPTION

Aspects and advantages of the present disclosure will be set forth in part in the following description, or may be obvious from the description, or may be learned through practice of the technology.

In accordance with one embodiment, a transformable creeper is provided. The creeper is configured to transform between a horizontal position for supporting a worker in a supine position and a seat position for supporting the worker working in an upright seating position. The creeper includes a base section and an upper section, each of the base section and the upper section comprising a longitudinally extending frame having side supports and transverse supports extending between the side supports; wheels coupled to the side supports of the base section configured to enable mobility of the creeper along a floor surface. The creeper further includes at least one pair of pivotally mounted arms coupled to both the upper section and the base section, the pair of pivotally mounted arms being pivotable between the horizontal position and the seat position. The creeper further includes at least one storage support interface coupled with one of the side supports, the storage support interface having at least two protrusions and a bracket receiving space formed between the at least two protrusions, the bracket receiving space being adapted to receive a complementary bracket, each protrusion comprising at least one angled side defining the bracket receiving space.

In accordance with another embodiment, a storage system includes a creeper and at least one modular accessory. The creeper includes a support for a user and wheels configured to enable mobility on a floor, and at least one storage support interface having two or more projections and a bracket receiving space between two projections. The at least one modular accessory includes a bracket configured to be mounted to the bracket receiving space.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present disclosure, including the best mode of making and using the present systems and methods, directed to one of ordinary skill in the art, is set forth in the specification, which makes reference to the appended figures, in which:

FIG. 1 is a side perspective view of a creeper in a horizontal configuration in accordance with embodiments of the present disclosure;

FIG. 2 is a front perspective view of a creeper in accordance with embodiments of the present disclosure;

FIG. 3 is a side perspective view of a creeper in a seating configuration in accordance with embodiments of the present disclosure;

FIG. 4 is a bottom view of a creeper in a horizontal configuration in accordance with embodiments of the present disclosure;

FIG. 5 is a partial bottom perspective view of an upper portion of a creeper in accordance with embodiments of the present disclosure;

FIG. 6 is a side perspective view of a creeper in a seating configuration in accordance with embodiments of the present disclosure;

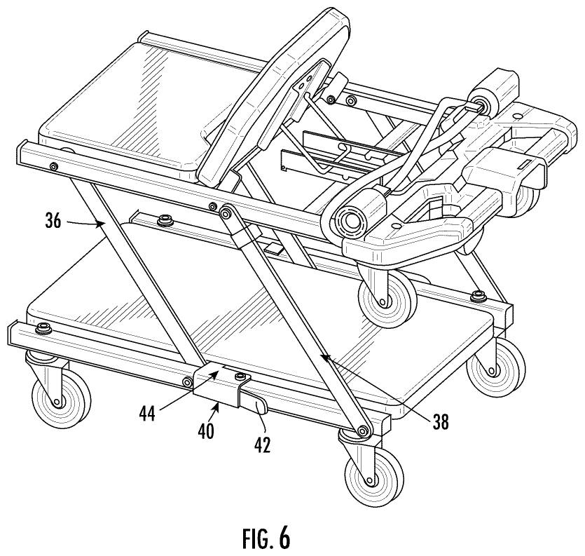

FIG. 7 is a partial side perspective view of an upper portion of a creeper in accordance with embodiments of the present disclosure;

FIG. 8 is a top perspective view of an upper portion of a creeper in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises.” “comprising.” “includes,” “including,” “bas,” “having” or any other variation thereof, are intended to cover a non-exclusive inclusion. For example, a process, method, article, or apparatus that comprises a list of features is not necessarily limited only to those features but may include other features not expressly listed or inherent to such process. method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

When used to describe a shape, the term “generally” is used to describe an object having the overall appearance of a shape and may include slight deviations from the exact shape, such as including one or more protrusions or indentations in the outline of the shape. For example, the term “generally rectangular” may be used to describe an object having the overall appearance of a rectangle having two sets of parallel sides and four right angles, but may include one or more indentations and/or protrusions along the parallel sides and/or slight variations in the right angles at the corners. For instance, a rectangular shape having slightly rounded corners may be described as “generally rectangular” as used herein. As a further example, a “generally rhomboid” or “generally diamond” shape may have the characteristics of a rhomboid or diamond (a quadrilateral of which only the opposite sides and angles are equal) but may have additional minor (e.g., shorter) sides interposed between the equal opposite angles and sides.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure is directed to a creeper that is transformable between a horizontal configuration and a seating configuration and that includes a storage support interface that is compatible with various tools and accessories of a storage system. The creeper may also include accessories coupled thereto or integrated therewith, such as one or more work lamps. A power source may be integrated with the creeper by providing a power source receptacle to couple a power source, e.g., a battery, to the creeper. The power source may be used to provide power to the work lamp(s) and/or to power other accessories or power tools plugged into the creeper.

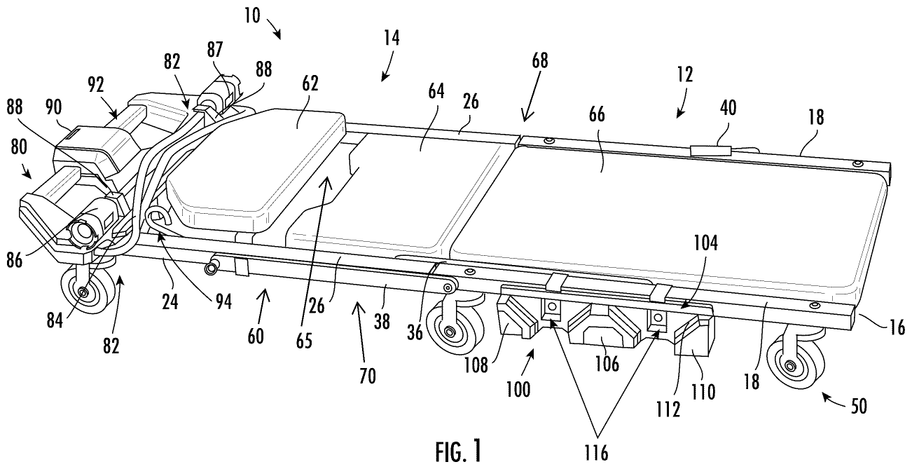

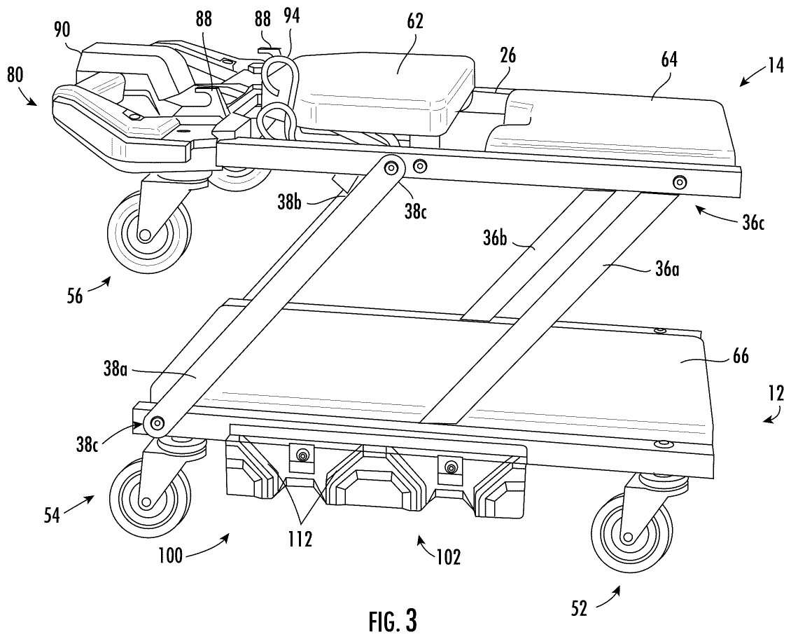

Referring now to the drawings, FIG. 1 illustrates a creeper 10 that is transformable or foldable between a horizontal configuration (see, e.g., FIG. 1) for a worker in a supine position, and a seating configuration (see, e.g., FIG. 3). The creeper 10 includes two separate longitudinally extending sections, a base section 12 and an upper section 14. As illustrated in FIGS. 1 and 3, base section 12 has a length in a longitudinal direction that may be generally equal to a length of upper section 14. When creeper 10 is configured in the horizontal configuration that one normally associates with a creeper, as shown in FIG. 1 for example, base section 12 and upper section 14 are positioned generally end-to-end so that their respective upper and lower surfaces are disposed in the same plane. However, upper section 14 may be pivotally connected to the base section 12. As illustrated in FIG. 3, when creeper 10 is configured in a seating position, upper section 14 is disposed to a position above and parallel to base section 12. For instance, when the configuration of creeper 10 is being changed from a seating position (FIG. 3) to a supine position (FIG. 1), upper section 14 is pivoted from above base section 12 to a position that is aligned and level with base section 12. When configured in this orientation with the upper section 14 disposed above the base section 12, the upper section 14 may define a seat for the user.

Each of the base section 12 and the upper section 14 includes a frame. The frame of each section defines an outline of part of the creeper 10 and has opposed upper and lower surfaces that extend longitudinally in parallel planes. Base section 12 is comprised of a base section frame 16 having side supports 18 and transverse supports 20 extending between the side supports 18. However, it should be appreciated that base section frame 16 can take on any manner of configurations and be formed by any manner and configuration of frame members.

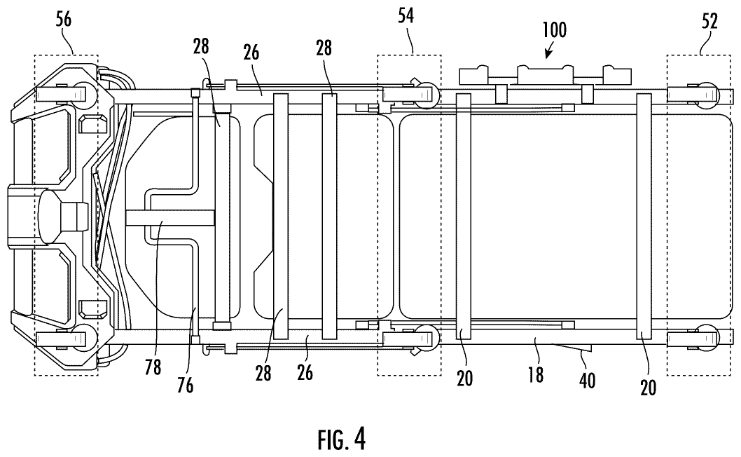

Likewise, upper section 14 includes an upper section frame 24 having sides 26 and transverse supports 28. The transverse supports 28 may extend between the upper section sides 26, as best seen in FIG. 4. In addition to the upper section frame 24, the upper section 14 may include an upper accessory body 80 (described in further detail below) coupled to the upper section frame 24, e.g., extending between the upper section sides 26. However, it should be appreciated that upper section frame 24 can take on any manner of configurations and be formed by any manner and configuration of frame members.

Each of base section 12 and upper section 14 may form an upper body support surface. The upper section 14 may include a support surface 60. The support surface 60 may optionally be formed including two distinct cushions, e.g., a head cushion 62 and a back cushion 64. The base section 12 may include an upper body support surface 66, which may also include a cushion. In the supine position of creeper 10 as illustrated in FIG. 1, the back cushion 64 and the base section support surface 66 may be generally flush and include transverse ends 68, 70, respectively. In the supine position, transverse ends 68, 70 may be directly opposite each other and longitudinally aligned. In an aspect of the disclosure, one or more of the cushions, such as the back cushion 64, may include a cut out 65 to permit an access space for a user's hand to pull up on the upper section 14 to transition the creeper 10 between the supine and seated positions.

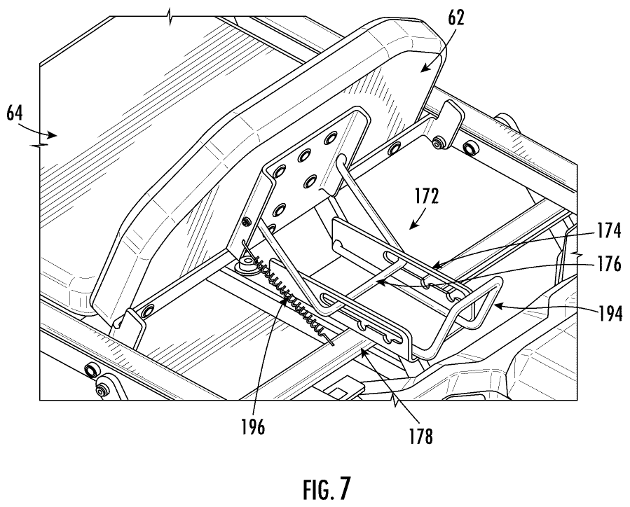

The head cushion 62 may have a shape and configuration to support the head of the operator when lying upon creeper 10 in the supine position. Additionally, the head cushion 62 may be independently movable relative to the back cushion 64 and the support surface 66. Specifically, FIG. 7 illustrates a pivot mechanism 72 coupled to a lower surface of the head cushion 62 and a transverse support 28. The pivot mechanism 72 includes a ratcheting mechanism 74 and an angle selection bar 76 configured to be received within one of a plurality of angle openings of the ratcheting mechanism 74. The ratcheting mechanism 74 may be further coupled to the head cushion 62 by a central support 78 extending in a longitudinal direction of the creeper 10. For instance, the ratcheting mechanism 74 may include three slots (angle opening) to support the head cushion 62 at three different angles other than the flat position. An operating handle 194 may be provided for adjustment of the angle of the head cushion 62. The operating handle 194 can be used to adjust the angle of the head cushion 62 by moving the angle selection bar 176 out of the slots of ratcheting mechanism 174, changing the angle, and re-inserting the angle selection bar 176 in another slot or enabling the head cushion 62 to lay flat.

The base section frame 16 and upper section frame 24 may be supported by wheels 50 (e.g., wheels provided with casters) to enable mobility of the creeper 10. For instance, the base section frame 16 may be provided with two or more pairs of wheels 52, 54. A first pair of wheels 52 may be disposed at or near an end of the base section 12 that is distal to the upper section 14, and a second pair of wheels 54 may be disposed at or near an end of the base section 12 that is proximal to the upper section 14. In this manner, the creeper 10 may be well-balanced and mobile when in the seating configuration (see FIG. 3) with the wheels 50 being spread apart and generally disposed near the corners of the base section 12. Additionally, a third pair of wheels 56 may be coupled to the upper section frame 24. For instance, the third pair of wheels 56 may be disposed at or near an end of the upper section 14 distal to the base section 12. In this manner, when the creeper 10 is in the supine position (FIG. 1), the third pair of wheels 56 and the first pair of wheels 52 may be disposed near the corners of the creeper 10 to maintain balance and mobility of the creeper 10. However, it should be appreciated that the number and arrangement of wheels 50 can take on any manner of configurations and be formed by any manner and configuration of wheels 50 to maintain balance and mobility of the creeper 10 in both the supine and seating positions.

The creeper 10 also includes at least one pair of pivotally mounted arms 36 mounted on opposing sides of the base section frame 16 and/or upper frame 24 and configured to enable pivoting of the upper section 14 between the supine and seating positions. For instance, the creeper 10 may include two such pairs of arms 36a, 36b and 38a, 38b. These arms may be pivotally mounted to the respective upper and base section frames 24, 16, for example by way of pivotal attachments 38c, so that upper section 14 can be pivoted or transitioned between the seating position and supine position. One or more locking latches 40 may be provided to lock the arms 36, 38 in a particular position. The locking latch(es) 40 may include an actuating tab 42 for a user to actuate the locking latch, and a blocking body 44 configured to prevent movement of the arms 36, 38 when the locking latch 40 is locked in position. For instance, the one or more locking latches 40 may lock the arms 36, 38 in the seating position and prevent the arms 36, 38 from pivoting back to the supine position. In other aspects, the one or more locking latches 40 may be oriented oppositely and may lock the arms 36, 38 in the supine position and prevent the arms 36, 38 from pivoting upward into the seating position.

When two pairs of arms are utilized, e.g., as illustrated in FIG. 3, the arms have generally the same length and operate in parallel to move the upper section 14 between the supine position and the seating position. However, it should be appreciated that the number and arrangement of pairs of arms can take on any manner of configurations and be formed by any manner and configuration of pairs of arms to pivot or transition the upper section 14 between the supine and seating positions, and support the upper section 14 in the seating position during use.

To transition the creeper 10 between the supine position and the seating position and back, a user may engage the actuating tab 42 of the locking latch 40 to move the blocking body 44 out of the way of the arms 36, 38. To transition from the supine position to the seating position, a user may then grasp the support surface 60, e.g., at the cut out 65, and pull upward to pivot the arms 36, 38 upward and raise the support surface 60 above the support surface 66 so the support surface 60 forms a seat. To transition from the seating position to the supine position, after engaging the actuating tab 42, a user may grasp the support surface 60 and pull in a direction away from the support surface 66 until the support surfaces 60 and 66 are aligned in parallel and form a supine position.

The creeper further includes a storage support interface 100. The storage support interface 100 may be coupled to the base section frame 16 and/or the upper section frame 24. In some aspects of the present disclosure, more than one storage support interface 100 may be provided, e.g., one or more storage support interfaces 100 coupled to the base section frame 16 and one or more storage support interfaces 100 coupled to the upper section frame 24. The storage support interface 100 may provide storage for tools and/or accessories, enhancing accessibility of the creeper 10 for the user.

The storage support interface 100 may have a body 102 extending in a generally longitudinal direction. The body 102 may be configured to be mounted along one of the side supports 18 or 26. In some aspects, one or more openings 118 may extend through the body 102 and are each configured to receive a fastener therein to secure the body 102 to a side support 18, 26. While FIG. 1 illustrates the storage support interface 100 coupled to a base section side support 18, the present disclosure contemplates coupling the storage support interface 100 to any desired support structure or part of the creeper 10, particularly any longitudinal support structure or frame.

The storage support interface body 102 may include a generally planar portion 104, a central protrusion 106 protruding outward relative to the planar portion 104, a first side protrusion 108 disposed at a first side of the body 102, and a second side protrusion 110 at a second side of the body 102. Each of the protrusions may alternatively be referred to as “cleats.” A slot 112 may be formed through the planar portion 104 along one or more edges of each cleat, e.g., to permit engagement of a complementary bracket. Further, each cleat may include an overhanging portion 114 along one or more edges thereof, e.g., along the slot(s) 112, to form a receiving space between the generally planar portion 104 and the overhanging portion 114 to hold a bracket therein. A mount may be formed between two adjacent protrusions, e.g., between the central protrusion 106 and the first side protrusion 108 and/or between the central protrusion 106 and the second side protrusion 110, with a bracket receiving space 116 formed along the generally planar portion 104 therebetween. One or more fastener openings 118 may be formed through the generally planar portion 104 to receive a fastener for fastening the body 102 to the side supports 18 or 26 as described above.

In some aspects of the present disclosure, as illustrated, each of the first side protrusion 108 and the second side protrusion 110 may be formed as generally one half of the central protrusion 106, i.e., a half cleat that is one-half of the geometric shape of the central protrusion 106. In this regard, when multiple storage support interfaces 100 are mounted adjacent to each other, a full cleat (in geometric shape) may be formed by the first and second side protrusions 108, 110 of the adjacent interfaces 100. Each of the cleats may have one or more angled sides that extend at an angle relative to a longitudinal axis of the body 102 and a vertical axis perpendicular to the longitudinal axis. In some aspects, each of the cleats may further include a vertical side or edge disposed below the angled surface, e.g., so the bracket receiving space 116 forms generally a Y-shape. While the illustrated embodiments show the storage support interface 100 with one full cleat and two half cleats, the storage support interface 100 may include any number, combination, and/or order of cleats, each of which may be any type of cleat (full, half, or any other type of cleat).

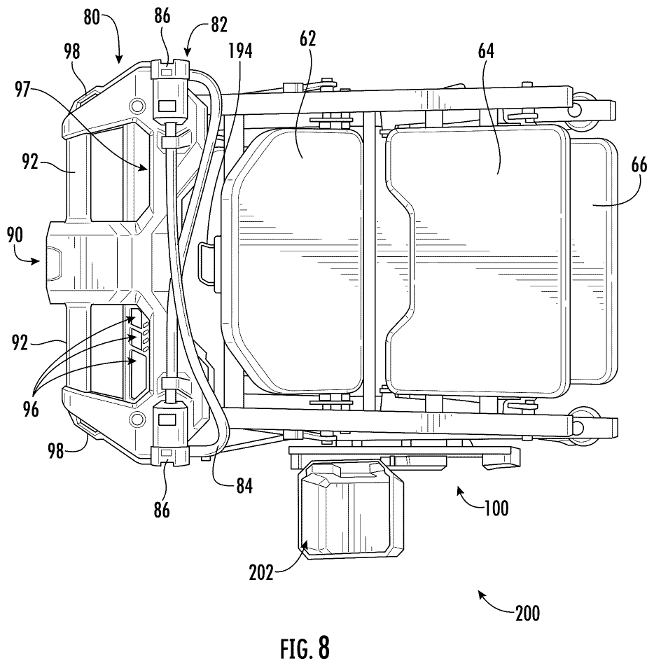

As described above, each bracket receiving space 116 may be configured to receive a complementary bracket, e.g., a Y-shaped bracket, of an accessory or tool of a complementary storage system. As illustrated in FIG. 8, a storage bin 202 may be coupled to the storage support interface 100, e.g., via a complementary bracket inserted in a bracket receiving space 116.

The storage support interface 100 may be integrated with a storage system 200 that includes various modular accessories configured to hold or support one or more objects or items (e.g., a hand tool, a power tool, a power tool accessory, a hand tool accessory, a small parts organizer, a small parts bin, a tray, a tool case, an accessory case, a tool holster, a battery holster, a drawer, a tool organizer, a belt clip, a cord wrap, a spool/reel holder, a cup holder, blades, batteries, paint containers, adhesive containers, and/or the like). The modular accessories may each include a complementary bracket configured to engage one or more mount interfaces. Each complementary bracket may be configured to be received in a bracket receiving space 116 of one of a variety of storage support interfaces 100, e.g., coupled with the creeper 10, a work bench, a stationary support such as a wall, a storage crate or tool box, etc. In this manner, the creeper 10 of the present disclosure is part of a storage system 200 that enables interchangeable storage and accessibility solutions for a user. The storage system may include any number and/or combination of storage components, such as any number and/or combination of wall rails, toolboxes, tool bags, shelves, crates, bins, and/or the like.

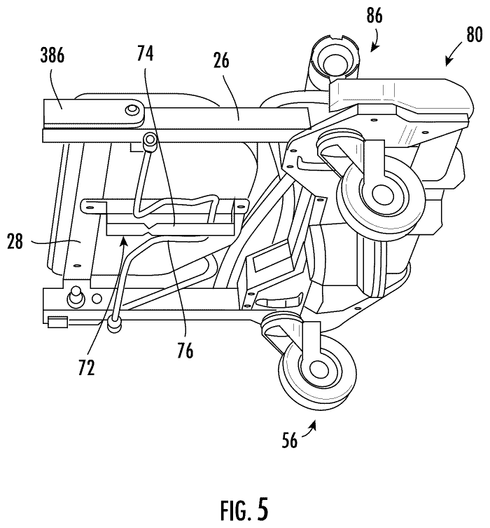

Returning to FIGS. 1-5 and 8, the creeper 10 further includes an upper accessory body 80 coupled to an end of the upper section frame 24. The upper accessory body 80 may extend between side supports 26 as shown in FIG. 1. One or more work lamps 82 may be coupled to the upper accessory body 80. For instance, the one or more work lamps 82 may be integrally formed with the upper accessory body 80. Each work lamp 82 may include a flexible arm 84 coupled to or extending from the upper accessory body 80 and a light source 86 at an opposite end of the flexible arm 84. Each flexible arm 84 may be in the form of a flexible gooseneck or any other suitable supporting arm that can be flexibly repositioned. In some aspects, the upper accessory body 80 may include one or more retainers 88 configured to hold a flexible arm 84 in place against the accessory body 80 when the work lamps 82 are not in use. Each retainer 88 may be in the form of a hook or any other suitable shape to hold the flexible arm 84 in place.

At least one light source 86 may include one or more actuators 87, such as a button, dial, switch, etc., that may be used to control a function of the light. Such functions may include on/off, brightness, light focus amount, etc. In some aspects, each light source 86 may include one or more actuators 87. In some aspects, a single actuator 87 may control functions of one or more light sources 86. The at least one light source 86 may include at least two modes, e.g., a high mode and a low mode. In some aspects, the high mode may be a higher relative brightness and the low mode may be a lower relative brightness.

The upper accessory body 80 may further include a power source receptacle 90 configured to receive a power source, e.g., a battery (such as a lithium ion 18V battery, or any other type and/or voltage battery). The power source receptacle 90 may provide electrical couplings to facilitate transmission of power from the power source to the light source(s) 86. Optionally, the upper accessory body 80 may include one or more additional electrically coupled receptacles configured to enable a user to plug in or charge a power tool, small electronic such as a cell phone or speaker, or other powered accessory and receive power from the power source. In some aspects, the creeper 10 may include a controller, such as a printed circuit board assembly (PCBA), to control operational functions of the creeper. Such functions may include operations to control the light sources, operations to control the power source including operations of charging and discharging, operations to control any additional accessories electrically coupled to the creeper 10, and operations to control of any other function performed by or with the creeper 10. The controller may be disposed anywhere on the creeper 10, including but not limited to in the upper accessory body 80 or in one or more of the light sources 86.

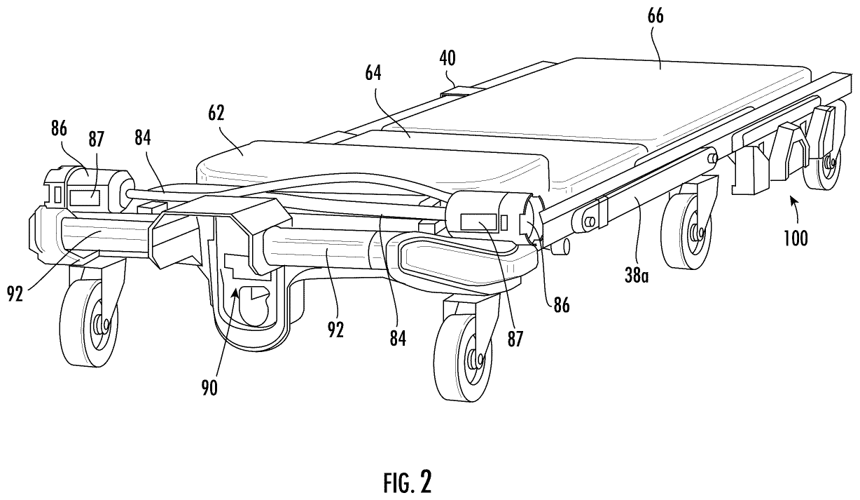

Further, as illustrated best in FIGS. 2 and 8, the upper accessory body 80 may also form one or more handles 92 configured to enable a user to easily grasp the upper section 14 of the creeper 10, e.g., to facilitate transitioning between the horizontal configuration, for a worker in a supine position, and seating configuration, and/or to guide movement and mobility of the creeper 10. For instance, two handles 92 may be provided, as shown in FIGS. 2 and 8, e.g., a handle 92 on each side on a central longitudinal axis of the creeper 10.

The upper accessory body 80 may be designed to provide additional storage for a user. For instance, the accessory body 80 may include a tray 94 configured to hold small parts such as screws, bolts, or other desired parts or accessories. The tray 94 may be aligned with one of the handles 92 or arranged in any suitable location of the accessory body 80. For instance, the tray 94 may be disposed on one side of the central longitudinal axis of the creeper 10.

The accessory body 80 may further include one or more storage slots 96 configured to support one or more hand tools or other elongated items therethrough. For instance, the accessory body 80 may include two or more, such as three or more, storage slots 96. The storage slots 96 may be configured for storing screwdrivers, ratchets, wrenches, bits, sockets, or any other hand tools or items that a user desires to store therein that fit within the slots 96. The storage slots 96 may be generally equally sized, or may have varying sizes, as shown in FIG. 8. In some aspects, the storage slots 96 may be located opposite the tray 94, and may be aligned with another one of the handles 92, e.g., on an opposite side of the central longitudinal axis of the creeper 10, relative to the tray 94.

The accessory body 80 may further include one or more built-in belt hook slots 98. As shown in FIG. 8, there may be two or more built-in belt hook slots 98 may be formed around an outer edge or perimeter of the accessory body 80. The belt hook slots 98 may be configured to hang or support tools from a complementary belt hook of the tool. For instance, some hand and/or power tools, e.g., an impact wrench, may include a belt hook that can be inserted through a belt hook slot 98 for storage during use of the creeper 10.

Further aspects of the disclosure are provided by one or more of the following embodiments:

A creeper is configured to transform between a horizontal position for supporting a worker in a supine position and a seat position for supporting the worker working in an upright seating position. The creeper includes a base section and an upper section, each of the base section and the upper section comprising a longitudinally extending frame having side supports and transverse supports extending between the side supports; wheels coupled to the side supports of the base section configured to enable mobility of the creeper along a floor surface. The creeper further includes at least one pair of pivotally mounted arms coupled to both the upper section and the base section, the pair of pivotally mounted arms being pivotable between the horizontal position and the seat position. The creeper further includes at least one storage support interface coupled with one of the side supports, the storage support interface having at least two protrusions and a bracket receiving space formed between the at least two protrusions, the bracket receiving space being adapted to receive a complementary bracket, each protrusion comprising at least one angled side defining the bracket receiving space.

The creeper of any one or more of the embodiments, further comprising an accessory body comprising at least one work lamp, each work lamp comprising a flexible arm extending from the accessory body and a light source.

The creeper of any one or more of the embodiments, wherein the at least one work lamp comprises two work lamps.

The creeper of any one or more of the embodiments, the accessory body being coupled to side supports of the upper section.

The creeper of any one or more of the embodiments, the accessory body comprising at least one wheel configured to enable mobility of the creeper in the horizontal position.

The creeper of any one or more of the embodiments, further comprising a power source receptacle configured to receive a power source therein.

The creeper of any one or more of the embodiments, wherein the power source receptacle comprises a battery receptacle and the power source is a battery configured to be coupled to the creeper.

The creeper of any one or more of the embodiments, further comprising an electrical receptacle configured to receive a power cord of a power tool or device to transmit power from the power source to the power tool or device.

A storage system comprising: a creeper comprising a support for a user and wheels configured to enable mobility on a floor, and at least one storage support interface comprising two or more projections and a bracket receiving space between two projections; and at least one modular accessory, the modular accessory comprising a bracket configured to be mounted to the bracket receiving space.

The storage system of any one or more of the embodiments, further comprising a storage structure having two or more projections and a bracket receiving space between two projections, wherein the bracket receiving space of the storage structure is configured to receive the bracket of the modular accessory such that the modular accessory is adapted to be mounted interchangeably with the storage support interface and the storage structure.

The storage system of any one or more of the embodiments, wherein the storage structure comprises at least one of: a wall rail, a toolbox, a tool bag, a shelf, a crate, a bin, and a workbench.

The storage system of any one or more of the embodiments, wherein the at least one modular accessory includes at least one of: a hand tool, a power tool, a power tool accessory, a hand tool accessory, a small parts organizer, a small parts bin, a tray, a tool case, an accessory case, a tool holster, a battery holster, a drawer, a tool organizer, a belt clip, a cord wrap, a spool/reel holder, and a cup holder.

The storage system of any one or more of the embodiments, wherein the creeper further comprises an accessory body comprising one or more of a work lamp and a power source receptacle, the accessory body being distinct from the storage support interface.

The storage system of any one or more of the embodiments, the accessory body including both the work lamp and the power source receptacle, wherein the work lamp is configured to be powered by a power source received by the power source receptacle.

The storage system of any one or more of the embodiments, wherein the creeper is transformable between a horizontal position and a seated position.

A creeper configured to support a worker in a supine position includes: a base section and an upper section, each of the base section and the upper section comprising a longitudinally extending frame having side supports and transverse supports extending between the side supports; wheels coupled to the side supports of the base section configured to enable mobility of the creeper along a floor surface; and an accessory body coupled to one or more of the side supports and/or transverse supports, the accessory body configured for storage of one or more tools and accessories during use of the creeper, the accessory body comprising: a power source receptacle configured to receive a power source therein.

The creeper of any one or more of the embodiments, wherein the power source receptacle comprises a battery receptacle and the power source is a battery configured to be coupled to the creeper.

The creeper of any one or more of the embodiments, the accessory body further comprising an electrical receptacle configured to receive a power cord of a power tool or device to transmit power from the power source to the power tool or device.

The creeper of any one or more of the embodiments, the accessory body further comprising a recessed tray configured to hold accessories therein, and at least one slot configured to receive a hand tool for storage of the hand tool.

The creeper of any one or more of the embodiments, further comprising a belt hook slot configured to enable the accessory body to support storage of a tool or accessory having a belt hook coupled thereto by receiving the belt hook of the tool or accessory in the belt hook slot.

An apparatus as shown and described in one or more embodiments herein.

A system configured to operate in accordance with any one or more embodiments disclosed herein.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A creeper configured to transform between a horizontal position for supporting a worker in a supine position and a seat position for supporting the worker working in an upright seating position, the creeper comprising:
a base section and an upper section, each of the base section and the upper section comprising a longitudinally extending frame having side supports and transverse supports extending between the side supports;
wheels coupled to the side supports of the base section configured to enable mobility of the creeper along a floor surface;
at least one pair of pivotally mounted arms coupled to both the upper section and the base section, the pair of pivotally mounted arms being pivotable between the horizontal position and the seat position; and
at least one storage support interface coupled with one of the side supports, the storage support interface comprising at least two protrusions and a bracket receiving space formed between the at least two protrusions, the bracket receiving space being configured to receive a complementary bracket, each protrusion comprising at least one angled side defining the bracket receiving space.

2. The creeper of claim 1, further comprising an accessory body comprising at least one work lamp, each work lamp comprising a flexible arm extending from the accessory body and a light source.

3. The creeper of claim 2, wherein the at least one work lamp comprises two work lamps.

4. The creeper of claim 2, wherein the accessory body is coupled to side supports of the upper section.

5. The creeper of claim 2, wherein the accessory body at least one wheel configured to enable mobility of the creeper in the horizontal position.

6. The creeper of claim 1, further comprising a power source receptacle configured to receive a power source therein.

7. The creeper of claim 6, wherein the power source receptacle comprises a battery receptacle and the power source is a battery configured to be coupled to the creeper.

8. The creeper of claim 6, further comprising an electrical receptacle configured to receive a power cord of a power tool or device to transmit power from the power source to the power tool or device.

9. A storage system comprising:
a creeper comprising a support for a user and wheels configured to enable mobility on a floor, and at least one storage support interface comprising two or more projections and a bracket receiving space between two projections; and
at least one modular accessory, the modular accessory comprising a bracket configured to be mounted to the bracket receiving space.

10. The storage system of claim 9, further comprising a storage structure having two or more projections and a bracket receiving space between two projections, wherein the bracket receiving space of the storage structure is configured to receive the bracket of the modular accessory such that the modular accessory is adapted to be mounted interchangeably with the storage support interface and the storage structure.

11. The storage system of claim 10, wherein the storage structure comprises at least one of: a wall rail, a toolbox, a tool bag, a shelf, a crate, a bin, and a workbench.

12. The storage system of claim 9, wherein the at least one modular accessory includes at least one of: a hand tool, a power tool, a power tool accessory, a hand tool accessory, a small parts organizer, a small parts bin, a tray, a tool case, an accessory case, a tool holster, a battery holster, a drawer, a tool organizer, a belt clip, a cord wrap, a spool/reel holder, and a cup holder.

13. The storage system of claim 9, wherein the creeper further comprises an accessory body comprising one or more of a work lamp and a power source receptacle, the accessory body being distinct from the storage support interface.

14. The storage system of claim 13, the accessory body including both the work lamp and the power source receptacle, wherein the work lamp is configured to be powered by a power source received by the power source receptacle.

15. The storage system of claim 9, wherein the creeper is transformable between a horizontal position and a seated position.

16. A creeper configured to support a worker in a supine position, the creeper comprising:
a base section and an upper section, each of the base section and the upper section comprising a longitudinally extending frame having side supports and transverse supports extending between the side supports;
wheels coupled to the side supports of the base section configured to enable mobility of the creeper along a floor surface; and
an accessory body coupled to one or more of the side supports and/or transverse supports, the accessory body configured for storage of one or more tools and accessories during use of the creeper, the accessory body comprising: a power source receptacle configured to receive a power source therein.

17. The creeper of claim 16, wherein the power source receptacle comprises a battery receptacle and the power source is a battery configured to be coupled to the creeper.

18. The creeper of claim 16, the accessory body further comprising an electrical receptacle configured to receive a power cord of a power tool or device to transmit power from the power source to the power tool or device.

19. The creeper of claim 16, the accessory body further comprising a recessed tray configured to hold accessories therein, and at least one slot configured to receive a hand tool for storage of the hand tool.

20. The creeper of claim 16, further comprising a belt hook slot configured to enable the accessory body to support storage of a tool or accessory having a belt hook coupled thereto by receiving the belt hook of the tool or accessory in the belt hook slot.
